(19) United States
(12) Patent Application Publication
(10) Pub. No.: US 2022/0410994 A1
(43) Pub. Date: Dec. 29, 2022

(54) RETROFITTING MECHANICAL WORKOVER RIG TO ELECTRO-MECHANICAL DRIVE

(71) Applicant: Bazean Corp., Houston, TX (US)

(72) Inventors: Abhishek Arya, Houston, TX (US); Lawrence Foard, IV, Grass Valley, CA (US); Roelof Jonkman, Mill Valley, CA (US); Samuel Newman, Boston, ME (US)

(21) Appl. No.: 17/808,945

(22) Filed: Jun. 24, 2022

Related U.S. Application Data
(60) Provisional application No. 63/202,824, filed on Jun. 25, 2021.

(51) Int. Cl. B62D 65/00; H02J 7/00; B60L 7/10; B60K 6/24; B60K 6/26; B60K 6/36; B60K 6/28; B60L 1/00; E21B 41/00

(52) U.S. Cl. CPC B62D 65/00; H02J 7/0063; B60L 7/10; B60K 6/24; B60K 6/26; B60K 6/36; B60K 6/28; B60L 1/00; E21B 41/00

(57) ABSTRACT

A system and method are disclosed for retrofitting mechanical workover rigs with electric motors to create a hybrid mechanical and electric drive. The process involves the replacement of the combustion engine with one or more electric motors to drive various components of the rig. The retrofit design allows for cleaner, more precise, and more efficient operations while eliminating the need for hydrocarbons as fuel and thus reducing associated greenhouse gas emissions. It also enables the installation of a computer control which, among other benefits, allows more precise control of the rig's operations than is possible with a mechanical transmission. The electric motors may be driven by a battery energy storage system.

### CROSS-REFERENCE TO RELATED APPLICATION

This Patent application claims priority to U.S. Provisional Patent Application No. 63/202,824 filed on Jun. 25, 2021, entitled “Retrofitting Mechanical Workover Rig to Electro-Mechanical Drive.” The disclosure of the prior application is considered part of and is incorporated by reference into this Patent Application.

### TECHNICAL FIELD

The present invention relates to the field of workover rigs used for oil & gas operations, and in particular to a system and technique for retrofitting a mechanical workover rig to a hybrid electric and mechanical drive.

### BACKGROUND ART

Workover rigs have been used for many decades in oil & gas operations for wellbore intervention, workover operations, and eventual plugging and abandonment of wellbores. They vary in scale and specific components but generally consist of a hoisting system, a circulation system, a rotation system, a power system, and a well control system. The prime movers within the power system are generally internal combustion engines reliant on diesel fuel.

As greenhouse gas emissions have come under increased scrutiny, a demand for cleaner oilfield operations has arisen with equipment powered by electricity rather than hydrocarbons. There do exist certain large rigs which are available in electric drive modes (generally higher horsepower rigs capable of drilling operations as well as workovers). However, there is currently no accepted method to utilize electricity to drive a workover rig's operations due to its mechanically driven nature.

### SUMMARY OF THE INVENTION

In one general aspect, a method of retrofitting a workover rig to a hybrid electro-mechanical drive comprises removing a prime mover engine of the workover rig; connecting a first electric motor set to a main transmission of the workover rig; connecting a second electric motor set to a drawworks of the workover rig; installing a power control system to intake and distribute power among components of the workover rig, installing a software-driven feedback and control system for the first electric motor set and the second electric motor set; and disconnecting electrical components of the workover rig from an alternator of the workover rig and connecting the electrical components to the power control system.

In a second general aspect, a retrofit kit for a mechanical workover rig to a hybrid electric mechanical drive comprises a first set of electric motors, configured for connection to a main transmission of the mechanical workover rig; a second set of electric motors, configured for connection to a drawworks of the mechanical workover rig; a power control system, configured for controlling electrical power across the mechanical workover rig; a feedback and control software for the first set of electric motors and the second set of electric motors.

### BRIEF DESCRIPTION OF DRAWINGS

The accompanying drawings, which are incorporated in and constitute a part of this specification, illustrate an implementation of apparatus and methods consistent with the present invention and, together with the detailed description, serve to explain advantages and principles consistent with the invention. In the drawings,

FIG. 1 is a simplified block diagram of a mechanical workover rig according to the prior art.

FIG. 2 is a block diagram illustrating a retrofit workover rig that is configured for towing by a secondary vehicle, such as a truck.

FIG. 3 is a block diagram illustrating a truck-mounted retrofit workover rig wherein the main engine is replaced by a smaller engine that powers the axles of the truck-mounted workover rig.

FIG. 4 is a block diagram illustrating a retrofit rig where an electric motor powers the axles of the truck-mounted workover rig.

FIG. 5 is a block diagram illustrating a mechanical drawworks being run with an electric motor by locking a variable speed transmission of the drawworks in a single gear ratio.

FIG. 6 is a block diagram illustrating a mechanical drawworks being run with an electric motor by direct connection after removing a variable speed transmission of the drawworks.

FIG. 7 is a block diagram illustrating a mechanical drawworks being run with an electric motor by connecting to a variable speed transmission of the drawworks, retaining the functionality of the transmission.

### DESCRIPTION OF EMBODIMENTS

In the following description, for purposes of explanation, numerous specific details are set forth in order to provide a thorough understanding of the invention. It will be apparent, however, to one skilled in the art that the invention may be practiced without these specific details. In other instances, structure and devices are shown in block diagram form in order to avoid obscuring the invention. References to numbers without subscripts are understood to reference all instances of subscripts corresponding to the referenced number. Moreover, the language used in this disclosure has been principally selected for readability and instructional purposes, and may not have been selected to delineate or circumscribe the inventive subject matter, resort to the claims being necessary to determine such inventive subject matter. Reference in the specification to “one embodiment” or to “an embodiment” means that a particular feature, structure, or characteristic described in connection with the embodiments is included in at least one embodiment of the invention, and multiple references to “one embodiment” or “an embodiment” should not be understood as necessarily all referring to the same embodiment.

Although some of the following description is written in terms that relate to software or firmware, embodiments can implement the features and functionality described herein in software, firmware, or hardware as desired, including any combination of software, firmware, and hardware. References to daemons, drivers, engines, modules, or routines should not be considered as suggesting a limitation of the embodiment to any type of implementation.

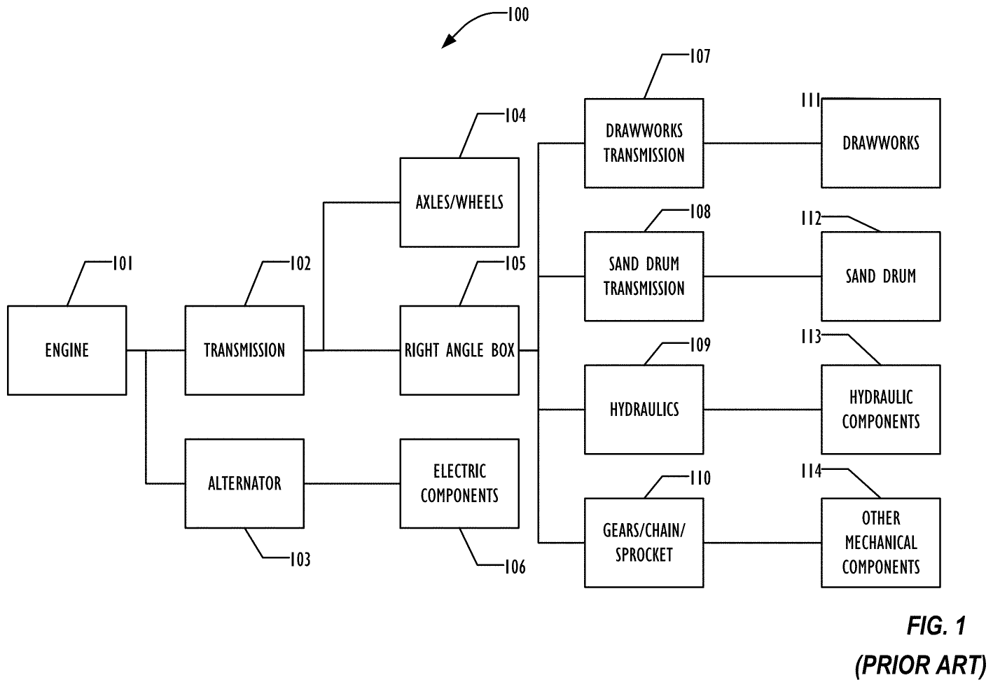

To power the rig via an electric input (e.g., a battery energy storage system or generators), the mechanical system needs modification. On a prior art mechanical rig 100 such as illustrated in FIG. 1, a main engine 101, typically a diesel engine, is connected to a transmission 102 via its crankshaft and flywheel/clutch/fluid coupling, which transfers engine power via a right-angle box 105 to a drawworks 111 via a drawworks transmission 107, a sand drum 112 via a sand drum transmission 108, hydraulics components 113 (e.g., mast hydraulics) via a hydraulics unit 109, and other mechanical components 114 via gears, chains, or sprockets 110, and to axles and wheels 104 of the rig 100. In addition, the main engine 101 may drive an alternator or generator 103 that converts mechanical energy into electrical energy to provide electrical power to electric components 106.

The engine 101 is the main power source (prime mover) on the rig 100 which utilizes diesel fuel and converts chemical energy in the diesel fuel into mechanical energy. The transmission 102 transmits the mechanical energy from the engine 101 to the axles and wheels 104, the drawworks 111, the sand drum 112, hydraulic components 113, and other mechanical components 114 on the rig 100 via a right-angle box 105 and various transmissions, such as drawworks transmission 107 and sand drum transmission 108, a hydraulics unit 109, and gears, chain, pulley systems, etc. 110 that serve as interconnects between the engine 101 and the drawworks 111, sand drum 112, hydraulics components 113, and other mechanical components 114. The transmission 102 is also responsible for speed and torque control. An alternator or generator 103 may also be driven by the engine 101 to provide electricity for electric components 106.

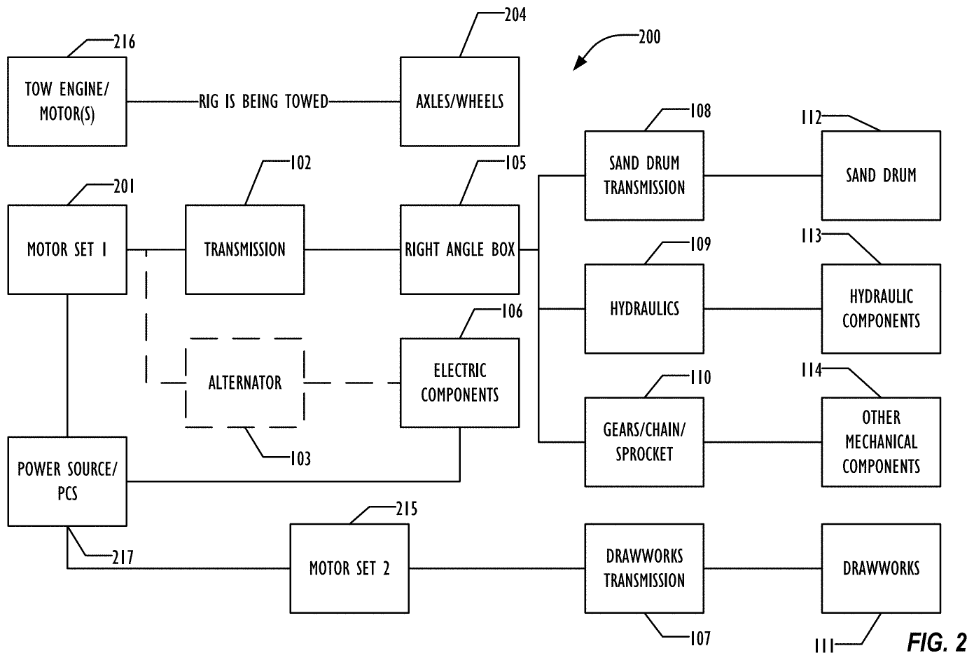

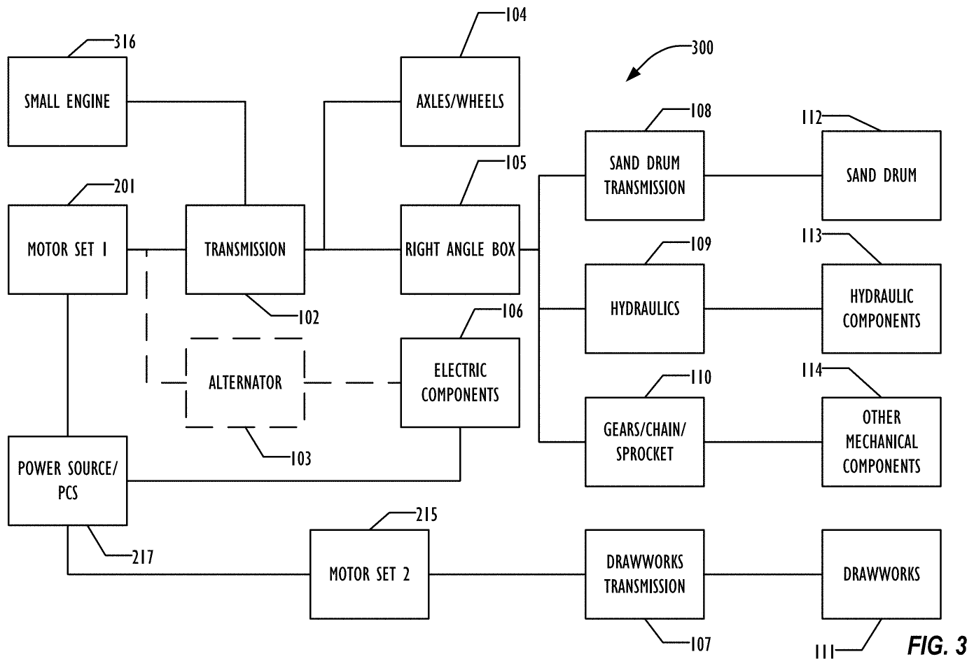

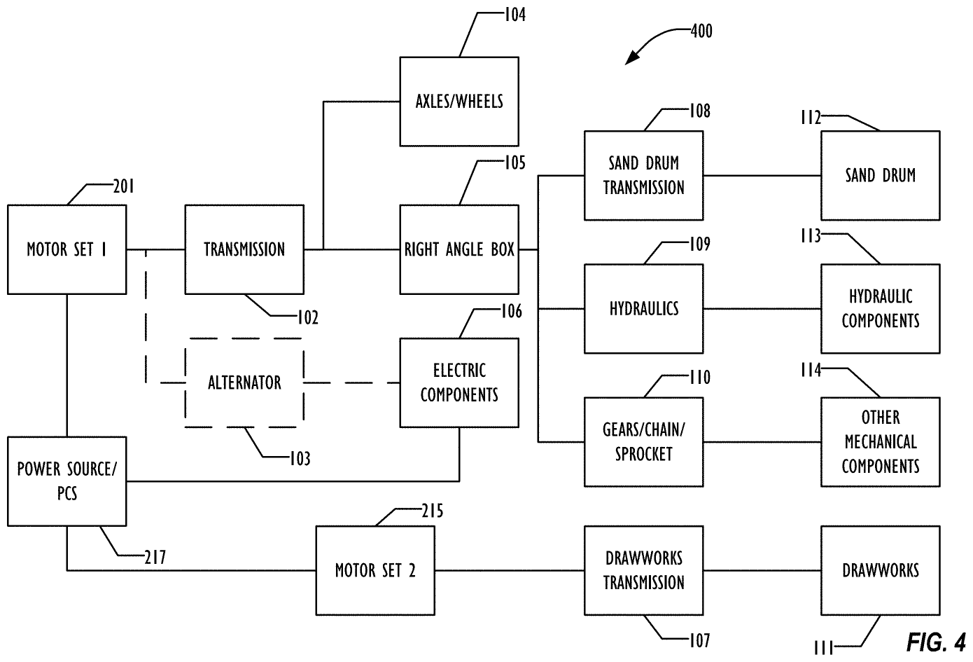

With an electro electro-mechanical workover rig, the need for the engine 101 may be much reduced if not eliminated, depending on the specific design. The retrofitted rig may be mounted on a trailer for the purposes of transportation, in which case the engine 101 may be eliminated altogether, as illustrated in the configuration of FIG. 2. Alternatively, in addition to adding the first motor set 201 and the second motor set 215, the existing engine 101 can either be replaced with a smaller sized engine 316, as in the self-propelled rig 300 illustrated in FIG. 3, or run with a smaller load with the sole purpose of transportation, by powering the axles of the equipment carrier (not shown). In the configuration illustrated in FIG. 4, the first motor set 401 is powerful enough to drive the axles and wheels 104 of the self-propelled rig 400, so no auxiliary combustion engine is needed. Although not illustrated in the figures, in some configurations the second motor set 215 may be eliminated and the entire rig driven by the first motor set 201.

Various embodiments provide a retrofit kit including the elements described below for retrofitting the mechanical workover rig to an electro-mechanical drive rig.

As disclosed below, one or more electric motor(s) may be installed, replacing the pre-existing engine 101. The electric motors will perform a similar functionality to the replaced engine 101 in driving the transmission 102 to power the components on the rig. In the embodiment of FIG. 2, the rig 200 is towed by a truck or other vehicle while electric motors power the remaining rig equipment.

A retrofit of the rig 200 as illustrated in FIG. 2 replaces the engine 101 with two motor sets, each comprising one or more electric motors, with a first motor set 201 replacing the engine 101 directly and a second motor set 215 independently driving the drawworks 111. A two-motor set design may provide higher efficiency and better control over the operations of the rig 200 than a single motor set design. Additional independent motor sets may be used as desired to power other components, such as a third motor set to drive the sand drum 112. depending on the equipment on the rig 200. Any desired type of electric motor may be used for the motor sets and either alternating current (AC) or direct current (DC) combined with a proper power conversion system may be used to power the electric motors as desired.

As illustrated in FIG. 2, the main engine 101 is disconnected from the transmission 102, removed, and replaced with a smaller capacity first motor set 201. The motor shaft size must be matched with the engine crankshaft size for easy replacement and connection with the main transmission 102 (or an adaptor is needed). The shaft size should be larger than the minimum shaft size such that it can bear the torsional shear and transfer the expected loads without breaking. The motor size is dictated by the equipment it must power. The first motor set 201 is designed to power the sand drum 112 (optional equipment), hydraulic components 113, and other mechanical components 114.

A drawworks transmission 107 for the drawworks 111 is typically a variable transmission that typically has four gear ratios: high-torque (high and low speed) and low-torque (high and low speed). The gear is shifted based on the operation currently underway. For example, a tripping operation from the bottom of the hole would have a heavy hook load so a suitable gear ratio might be high-torque low-speed.

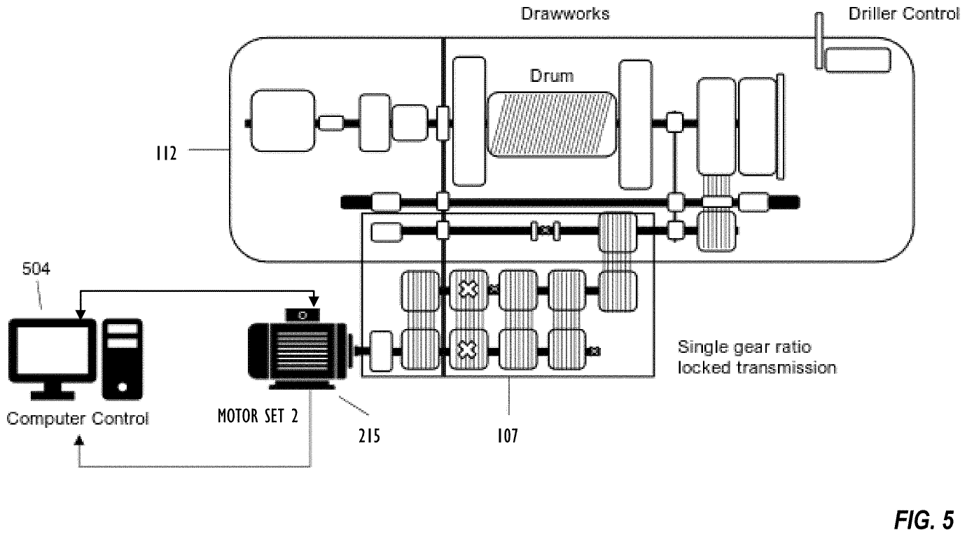

A technique for retrofitting the drawworks 111 is illustrated in FIG. 5. The drawworks transmission 107 is disconnected from the rig 200's main transmission 102. The drawworks transmission 107 is locked to a single gear ratio 502 and is connected to the second motor set 215, matching the motor shaft(s) to replace the main transmission 102 shaft size with similar design considerations as described for the main engine replacement with the first motor set 201). This second motor set 215 is solely responsible for powering the drawworks 111.

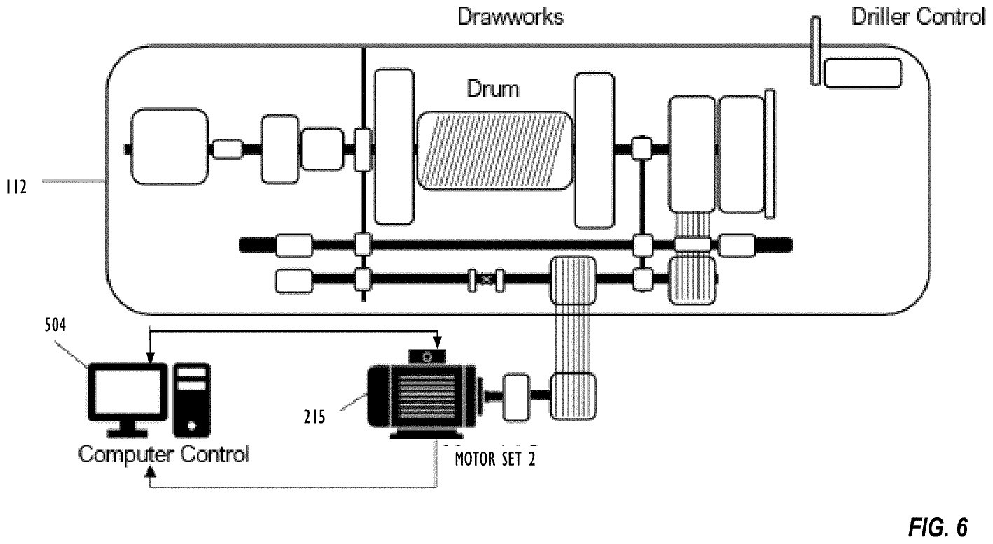

An alternate technique that may enhance control and precision is illustrated in FIG. 6. Instead of locking the drawworks transmission 107 into a single gear ratio as illustrated in FIG. 5, the drawworks transmission 107 is disconnected from the drawworks 111. Then, the second motor set 215 is connected directly to the drawworks 111, matching the motor shaft to replace the drawworks transmission 107 shaft size going to the drawworks 111 with similar design considerations as described for the main engine replacement with the first motor set 201.

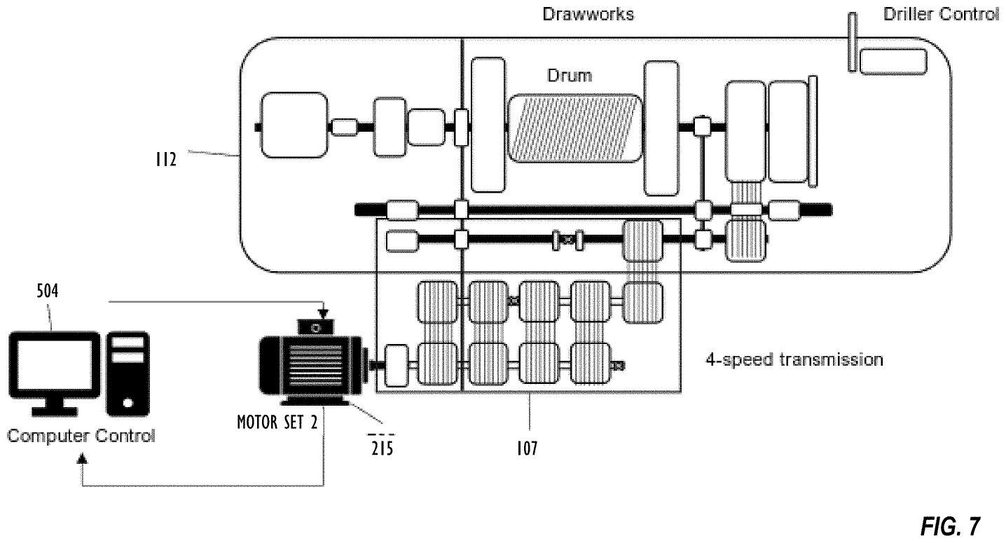

A third, simpler embodiment is illustrated in FIG. 7. Instead of locking the drawworks transmission 107 into a single gear ratio as illustrated in FIG. 5, the capability of the variable gear ratios is preserved. Then, the drawworks transmission 107 is connected to the second motor set 215, matching the motor shaft to replace the main transmission shaft size with similar design considerations as are described for the main engine 101 replacement with the first motor set 201. This second motor set 215 is solely responsible for powering the drawworks 111. This allows for using gear ratios like high-torque low-speed, or high-speed low-torque and distributing the wear and tear over all the gear ratios.

To drive the first motor set 201 and the second motor set 215, a power control system 217 may be installed to intake, regulate, and distribute power to the components of the rig 200. The power control system may integrate all the motor controllers for each motor in one place (shown) or may be present as separate units with each motor (not shown). If AC motors are used for the first motor set 201 or the second motor set 215, they may be connected to variable frequency drives (not shown) for speed and torque control. If DC motors are used for the first motor set 201 or the second motor set 215, a controller using thyristors, insulated-gate bipolar transistors (IGBTs), metal-oxide-semiconductor field-effect transistors (MOSFETs), other semiconductors (not shown) may be included as part of the power control system 217. An inverter (not shown) may also be used for the ancillary systems if they are AC electric or hydraulically run.

The electrical components 206 of the rig 200 are disconnected from the alternator or generator 103 (which is driven by the first motor set 201) and powered by directly connecting to the power source and power control system 217 for increased energy efficiency. Optionally, the alternator or generator 103 may be retained and continued to be powered by the first motor set 201 and the electrical components 106 run by the electricity generated by the alternator or generator 103.

Because the rig 200 of FIG. 2 is a trailer-mounted rig that is towed by a vehicle (not shown), the engine 216 of the vehicle provides towing power to the axle/wheels 204 of the rig 200, rather than driving them directly.

In some embodiments, the alternator or generator 103 may be eliminated, and electrical power provided from the power control system 217 to electric components 106. If the power control system 217 is AC and the electric components 106 are DC, a power converter such as an inverter (not shown) may be used. Alternately, the first motor set 201 may continue to drive an alternator or generator 103 for powering the electrical components 106 of the rig 200.

A computer control 504 that is software-driven may be added to the feedback loop of each of the motor controllers (not shown) for the motor(s) on the rig, that assists in the oil and gas operations. The computer control 504 may be comprised of sensors and algorithmic-based software that assists in controlling acceleration, speeds, maximum allowed tension (force), partial cycling motions to assist in workover operations, and more. The computer control 504 may provide more precise control of the motor than possible with a mechanical transmission. This can improve operations by, for example, helping to minimize the occurrence of broken strings in a dilapidated wellbore situation that result in expensive fishing jobs.

Capacitors and flywheels (not shown) may be included to store excess energy within a regenerative braking system. These systems can be used to power the motors, reducing energy costs and further increasing operational efficiency.

While certain exemplary embodiments have been described in detail and shown in the accompanying drawings, it is to be understood that such embodiments are merely illustrative of and not devised without departing from the basic scope thereof, which is determined by the claims that follow.

We claim:

1. A method of retrofitting a workover rig to a hybrid electro-mechanical drive, comprising:
removing a prime mover engine of the workover rig;
connecting a first electric motor set to a main transmission of the workover rig;
connecting a second electric motor set to a drawworks of the workover rig;
installing a power control system to intake and distribute power among components of the workover rig,
installing a software-driven feedback and control system for the first electric motor set and the second electric motor set; and
disconnecting electrical components of the workover rig from an alternator of the workover rig and connecting the electrical components to the power control system.

2. The method of claim 1, wherein connecting the second electric motor set to the drawworks of the workover rig comprises connecting the second electric motor set to the drawworks of the workover rig via a drawworks transmission or directly without the drawworks transmission.

3. The method of claim 1, further comprising:
powering an ancillary system on the workover rig independently by an electric motor set.

4. The method of claim 1, further comprising:
powering axles of the workover rig by an engine.

5. The method of claim 1, further comprising:
storing excess energy in a regenerative braking system.

6. The method of claim 1, further comprising:
powering the power control system from a battery energy storage system coupled to the power control system.

7. The method of claim 1, further comprising disconnecting electrical components of the workover rig from an existing alternator or generator.

8. A retrofit kit for a mechanical workover rig to a hybrid electric mechanical drive, comprising:
a first set of electric motors, configured for connection to a main transmission of the mechanical workover rig;
a second set of electric motors, configured for connection to a drawworks of the mechanical workover rig;
a power control system, configured for controlling electrical power across the mechanical workover rig;
a feedback and control software for the first set of electric motors and the second set of electric motors.

9. The retrofit kit of claim 8, further comprising:
a battery energy storage system, configured for coupling to the power control system.

10. The retrofit kit of claim 8, further comprising a third set of electric motors, configured for independently powering an ancillary system of the mechanical workover rig.

11. The retrofit kit of claim 8, wherein the second set of electric motors is configured for connection to a drawworks transmission of the mechanical workover rig.

12. The retrofit kit of claim 8, wherein a shaft of the second motor set is matched to replace a drawworks transmission shaft size for direct connection to the drawworks.

13. The retrofit kit of claim 8, further comprising an engine configured for powering axles of the mechanical workover rig.

14. The retrofit kit of claim 8, wherein the first set of electric motors comprises a single electric motor.

15. The retrofit kit of claim 8, wherein the second set of electric motors comprises a single electric motor.

16. The retrofit kit of claim 8, further comprising a regenerative braking system configured to store excess energy for powering the first set of electric motors or the second set of electric motors.

17. The retrofit kit of claim 8, further comprising sensors for use with the feedback and control software.

18. The retrofit kit of claim 8, wherein the feedback and control software is configured for controlling acceleration of the mechanical workover rig.

19. The retrofit kit of claim 8, wherein the feedback and control software is configured for controlling maximum allowed tension during workover operations.

20. The retrofit kit of claim 8, wherein the mechanical workover rig is a trailer-mounted rig configured for towing by a vehicle.
